(19) United States
(12) Patent Application Publication
(10) Pub. No.: US 2022/0145698 A1
(43) Pub. Date: May 12, 2022

(54) FOLDING/UNFOLDING DEVICE FOR A WINDOW SHADE

(71) Applicant: WEI-SHUN HONG, CHANGHUA COUNTY (TW)

(72) Inventor: WEI-SHUN HONG, CHANGHUA COUNTY (TW)

(21) Appl. No.: 17/095,915

(22) Filed: Nov. 12, 2020

(51) Int. Cl. E06B 9/68; E06B 9/262; E06B 9/322; E06B 9/78

(52) U.S. Cl. CPC E06B 9/68; E06B 9/262; E06B 2009/785; E06B 9/78; E06B 9/322

(57) ABSTRACT

A folding/unfolding device drives a reel shaft to rotate to thereby fold or unfold a shade of a window shade through a string. The folding/unfolding device includes a folding/unfolding unit is mounted to a top frame or a bottom frame of the shade and includes a screw rod on which a first gear is mounted. A second gear is mounted on the reel shaft and directly or indirectly meshes with the first gear. A single direction driving unit is mounted around and movable along the screw rod. When the single direction driving unit moves along the screw rod and towards the first gear, the screw rod is driven to rotate the reel shaft through the first and second gears. When the single direction driving unit moves along the screw rod and away from the first gear, the screw rod is not rotated.

### BACKGROUND OF THE INVENTION

The present invention relates to a window shade device and, more particularly, to a folding/unfolding device for a window shade.

In modern rooms, in addition to shielding from the sunlight and providing privacy, window shades provide room decoration and show the user's taste. A typical window shade includes a shade unit that can be moved upward or downward by operating a pull cord. To avoid a playful child from being strangled by the exposed length of the pull cord, pull-cord-free window shades have become the trend in the technology and the market. A pull-cord-free window shade in an unfolded state is maintained by a balance between a gravitational force and an elastic returning force of a spring unit disposed in a folding/unfolding device, and slight manual operation destroys the balance and, thus, folds the window shade. However, the spring unit is complicated, expensive, and difficult to assemble.

Taiwan Patent No. 1422346 discloses a controlling device for folding and unfolding a window shade through a shade reel. The controlling device includes a screw rod coupled to the shade reel to rotate therewith. The screw rod includes at least one helical groove. The screw rod extends through a control unit that includes a driving seat. A receiving space is defined by the driving seat and a coupling seat. The driving seat includes at least one driving block extending into the receiving space. An interlocking unit includes an interlocking seat rotatable relative to the screw rod and movable in the receiving space. The interlocking seat has at least one interlocking block capable of pressing against the at least one driving block. When the control unit moves along a length direction of the screw rod to press the at least one driving block against the at least one interlocking block, the screw rod rotates in a first direction, and the controlling device is in a driving position. When the control unit moves in the length direction of the screw rod and when the coupling seat is aligned with the interlocking unit, the interlocking seat rotates along the screw rod, and the controlling device moves to a non-driving position. Although an expected effect is achieved, this structure is, however, relatively complicated and difficult to process. Furthermore, in a case that the screw rod extends in a vertical direction, the control unit moves up and down along the screw rod. When the window shade is heavy, the gravitational force imparted to the window shade could urge the shade reel to rotate and, thus, affects the screw rod in the reverse direction, such that the screw rod cannot be easily controlled by the control unit. Namely, prevention of reverse rotation is not fully considered in the interlocking relationship.

### BRIEF SUMMARY OF THE INVENTION

In view of the drawbacks of the prior art, the present invention provides a folding/unfolding device for a window shade. The folding/unfolding device is configured to drive a reel shaft to rotate to thereby fold or unfold a shade through a string. The folding/unfolding device comprises a folding/unfolding unit configured to be mounted to a top frame or a bottom frame of the shade and extending in a transverse direction. The folding/unfolding unit includes a screw rod having an end on which a first gear is mounted. The screw rod is disposed on a side of the reel shaft. A second gear is mounted on an end of the reel shaft and directly or indirectly meshes with the first gear. A single direction driving unit is mounted around and movable along the screw rod. When the single direction driving unit moves along the screw rod and towards the first gear, the screw rod is driven to rotate the reel shaft through the first and second gears. When the single direction driving unit moves along the screw rod and away from the first gear, the screw rod is not rotated.

In an example, the single direction driving unit includes a ratchet tooth sleeve having a through-hole extending from an end through another end of the ratchet tooth sleeve. The screw rod extends through the through-hole. The ratchet tooth sleeve includes an inner periphery with a rotational mechanism configured according to a helical form of the screw rod. The ratchet tooth sleeve includes an outer periphery having a ratchet tooth edge. A pawl sleeve is mounted around the ratchet tooth sleeve and includes a pawl movable in an annular path relative to the ratchet tooth edge. When the single direction driving unit moves towards the first gear, the pawl engages with the ratchet tooth edge to prevent rotation of the ratchet tooth sleeve, and the screw rod rotates. When the single direction driving unit moves away from the first gear, the ratchet tooth sleeve rotates but the screw rod does not rotate.

In an example, a connecting sleeve is mounted around the pawl sleeve. The pawl sleeve includes two symmetric keys on an outer periphery thereof. The connecting sleeve includes an inner periphery having two symmetric key grooves receiving the two symmetric keys. A handgrip is connected to an outer side of the connecting sleeve.

In an example, the first gear is mounted on a portion of a shaft. An actuating plate is coupled to an exposed outer end of the shaft. The shaft includes an exposed inner end having a polygonal section. The polygonal section extends into an opening of a sleeve coupled to the end of the screw rod. The opening has a polygonal groove corresponding to the polygonal section, such that the first gear is driven by the screw rod to rotate when the screw rod rotates. The second gear includes an inner end having a polygonal groove. The end of the reel shaft has a polygonal axle corresponding to the polygonal groove of the second gear. The reel shaft and the second gear are interlocked through engagement between the polygonal axle of the reel shaft and the polygonal groove of the second gear.

In an example, the single direction driving unit further includes a pull cord disposed on a side facing the first gear. A roller is securely mounted to the folding/unfolding unit. The pull cord is wound around the roller and extends downwards.

Since the pawl of the pawl sleeve and the ratchet tooth edge provide a restraining effect in the reverse direction and a non-restraining effect in the forward direction, when the single direction driving unit moves towards the first gear, the pawl engages with the ratchet tooth edge to prevent rotation of the ratchet tooth sleeve, and the screw rod rotates to interlock the transmission gear and then the second gear, rotating the reel shaft. As a result, the string coils around the reel shaft to fold the shade. The shade can be easily and safely folded through the single direction driving unit.

The present invention will become clearer in light of the following detailed description of illustrative embodiments of this invention described in connection with the drawings.

### DESCRIPTION OF THE DRAWINGS

FIG. 1 is a perspective view of a folding/unfolding device of an embodiment according to the present invention mounted to a bottom frame of a window shade.

FIG. 2 is a perspective view of the folding/unfolding device according to the present invention coupled to the bottom frame.

FIG. 3 is an exploded, perspective view of the folding/unfolding device and the bottom frame.

FIG. 4 is a cross sectional view of a single direction driving unit shown in FIG. 6 after assembly.

FIG. 5 is an exploded, perspective view of a folding/unfolding unit and components around the folding/unfolding unit according to the present invention.

FIG. 6 is an exploded, perspective view of the single direction driving unit according to the present invention.

FIG. 7 is a diagrammatic view illustrating operation of the folding/unfolding device according to the present invention.

FIG. 8 is a perspective view of a folding/unfolding device of an embodiment according to the present invention mounted to a top frame of a window shade.

FIG. 9 is a perspective view of a folding/unfolding device of another embodiment according to the present invention.

FIG. 10 is a perspective view of a ratchet tooth sleeve, a pawl sleeve, and a connecting sleeve of the folding/unfolding device according to the present invention.

FIG. 11 is a partly-cutaway perspective view of the folding/unfolding device mounted to a top frame of a window shade.

### DETAILED DESCRIPTION OF THE INVENTION

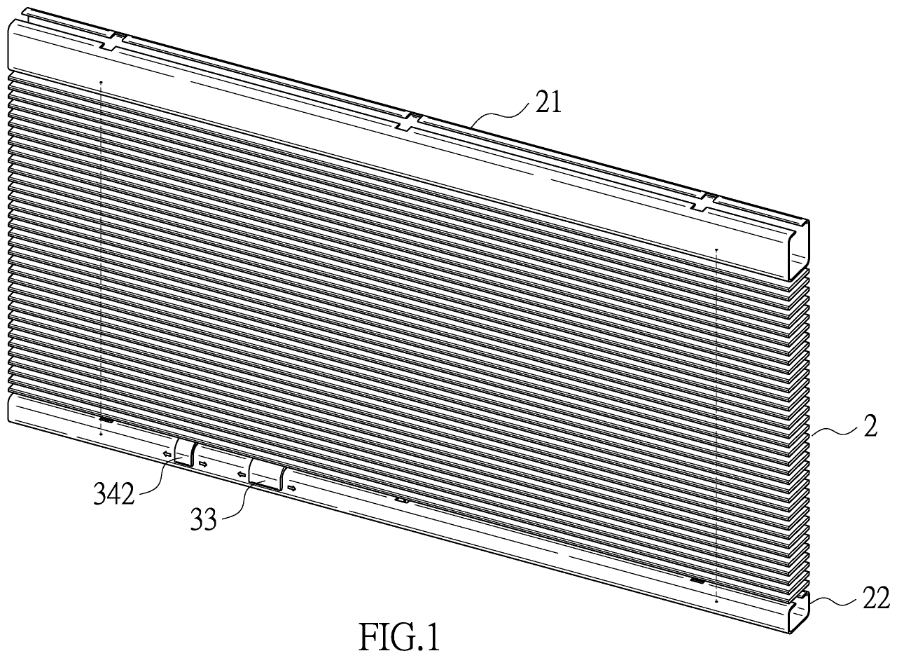

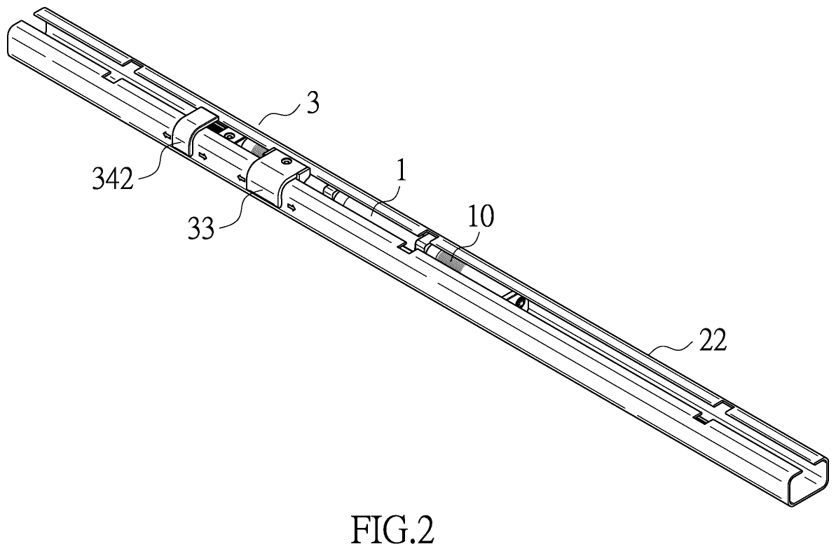

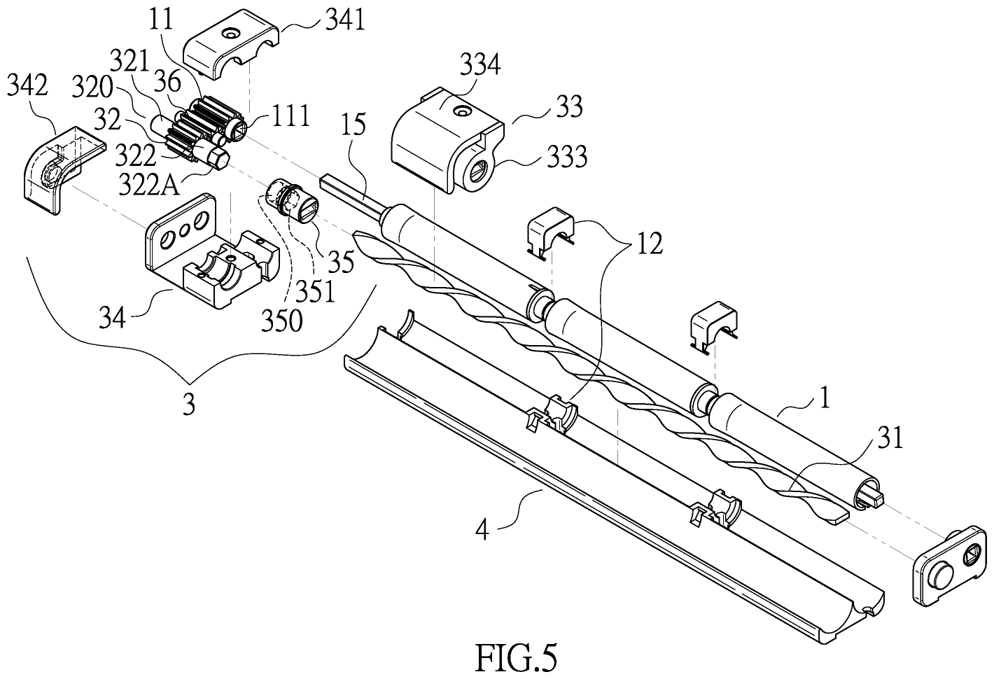

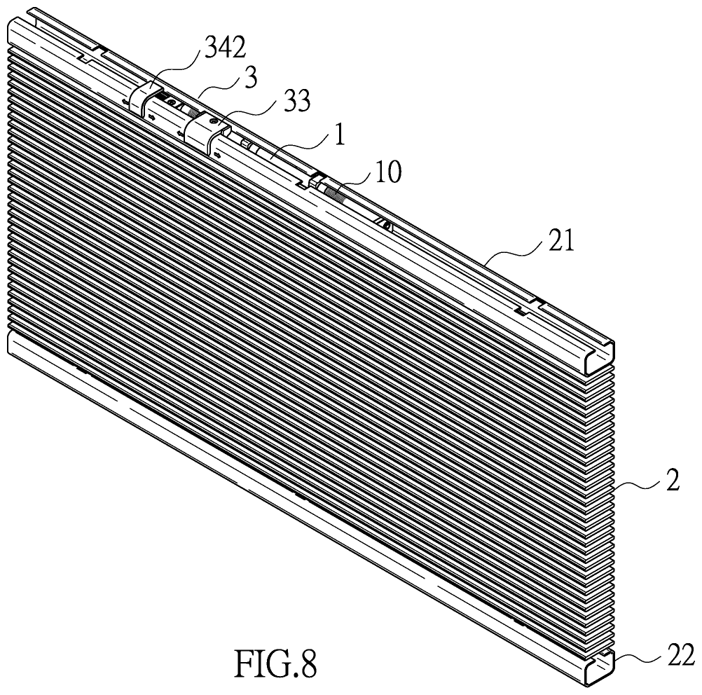

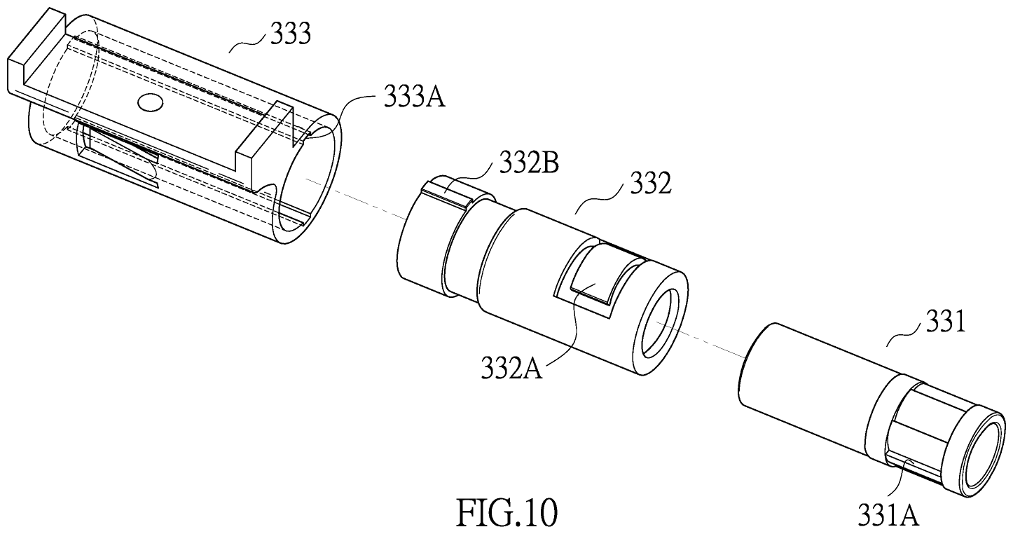

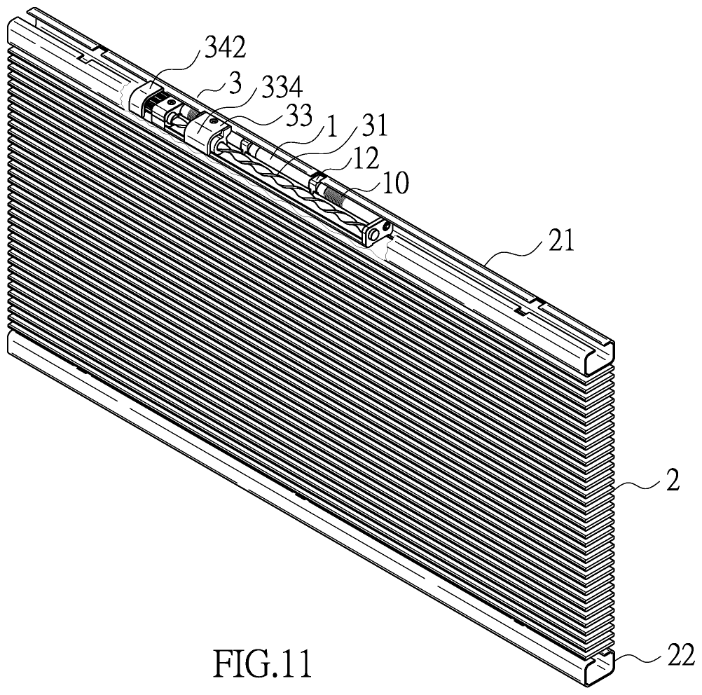

With reference to FIGS. 1-7, a folding/unfolding device for a window shade according to the present invention is configured to drive a reel shaft 1 (see FIG. 5) to rotate to thereby fold or unfold a shade 2 through one or more strings 10 (see FIG. 10) depending on the size of the window shade. Folding and unfolding of the shade 2 are an ordinary skill in the art and, therefore, will not be described in detail to avoid redundancy. The folding/unfolding device comprises a folding/unfolding unit 3 configured to be mounted to a top frame 21 (see FIGS. 8 and 11) or a bottom frame 22 (see FIG. 1) of the shade 2 and extending in a transverse direction.

With reference to FIG. 5, the folding/unfolding unit 3 includes a screw rod 31 having an end on which a first gear 32 is mounted. The screw rod 31 is disposed on a side of the reel shaft 1. A second gear 11 is mounted on an end of the reel shaft 1 and directly or indirectly meshes with the first gear 32. A single direction driving unit 33 is mounted around and movable along the screw rod 31. When the single direction driving unit 33 moves along the screw rod 31 and towards the first gear 32, the screw rod 31 is driven to rotate the reel shaft 1 through the first and second gears 32 and 11. On the other hand, when the single direction driving unit 33 moves along the screw rod 31 and away from the first gear 32, the screw rod 31 is not rotated.

With reference to FIG. 5, the single direction driving unit 3 and the reel shaft 1 can be received in a first double U-shaped groove seat 4 in a parallel relation, providing a secure arrangement. The first gear 32 and the second gear 11 are disposed in a second double U-shaped groove seat 34 in a parallel relation, providing a secure arrangement. A cover 341 can be provided to cover the second double U-shaped groove seat 34 for shielding purposes and completeness.

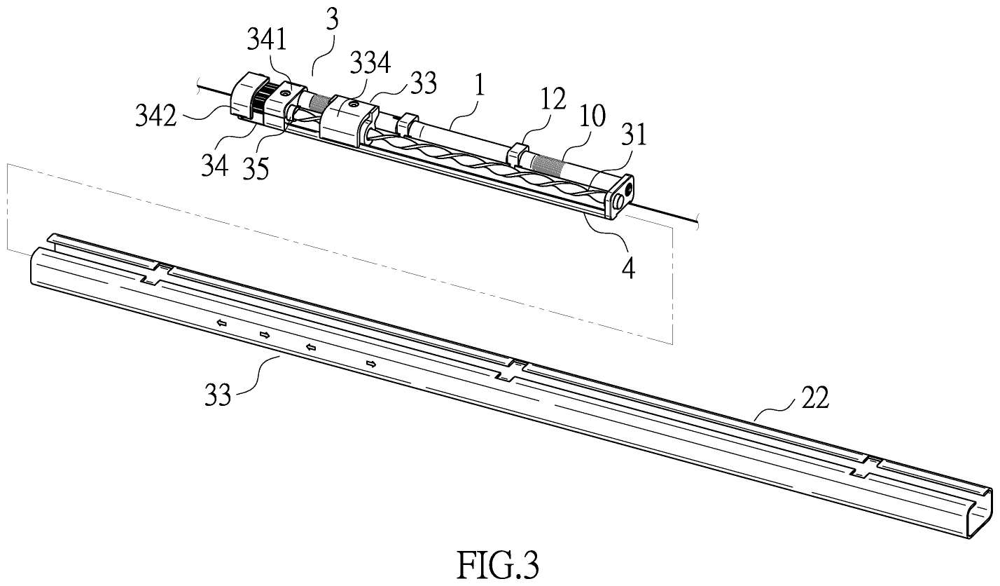

With reference to FIG. 5, a transmission gear 36 can be disposed between the first gear 32 and the second gear 1 to allow adjustment of the rotating speed. The strings 10 (see FIG. 3) can be wound around a plurality of sections of the reel shaft 1. Each two adjacent sections can have a coupling unit 12 for clamping purposes, thereby providing secure positioning in the first double U-shaped groove seat 4.

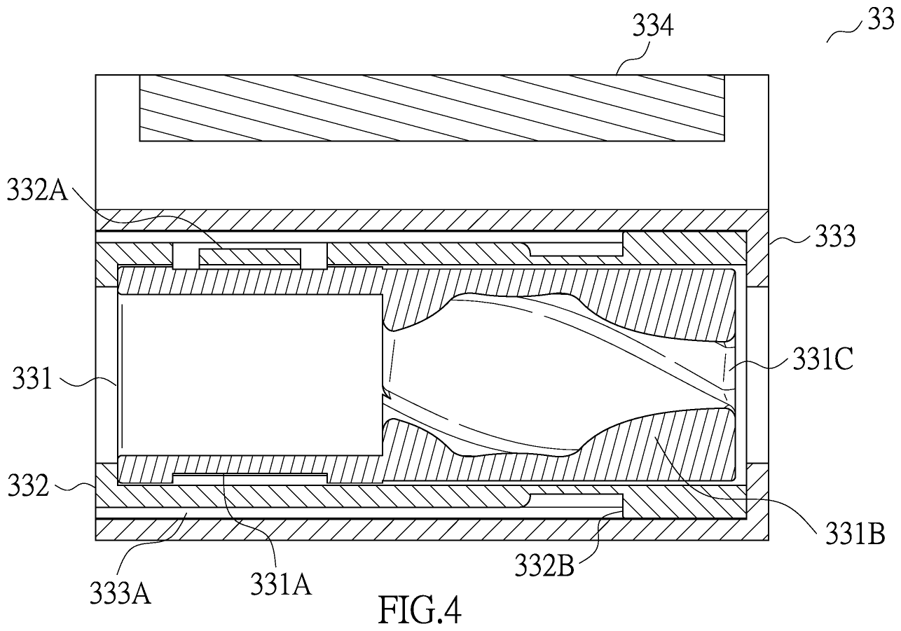

With reference to FIGS. 4, 6 and 10, the single direction driving unit 33 includes a ratchet tooth sleeve 331 having a through-hole 331C extending from an end through another end of the ratchet tooth sleeve 331. The screw rod 31 extends through the through-hole 331C. The ratchet tooth sleeve 331 includes an inner periphery with a rotational mechanism configured according to a helical form of the screw rod 31. In this embodiment, the rotational mechanism is a helical mechanism 331B. Furthermore, the ratchet tooth sleeve 331 includes an outer periphery having a ratchet tooth edge 331A. A pawl sleeve 332 is mounted around the ratchet tooth sleeve 331 and includes a pawl 332A movable in an annular path relative to the ratchet tooth edge 331A, providing a restraining effect in the reverse direction and a non-restraining effect in the forward direction. Specifically, when the single direction driving unit 33 moves towards the first gear 32, the pawl 332A engages with the ratchet tooth edge 331A to prevent rotation of the ratchet tooth sleeve 331, and the screw rod 31 rotates. On the other hand, when the single direction driving unit 33 moves away from the first gear 32, the ratchet tooth sleeve 31 rotates but the screw rod 31 does not rotate.

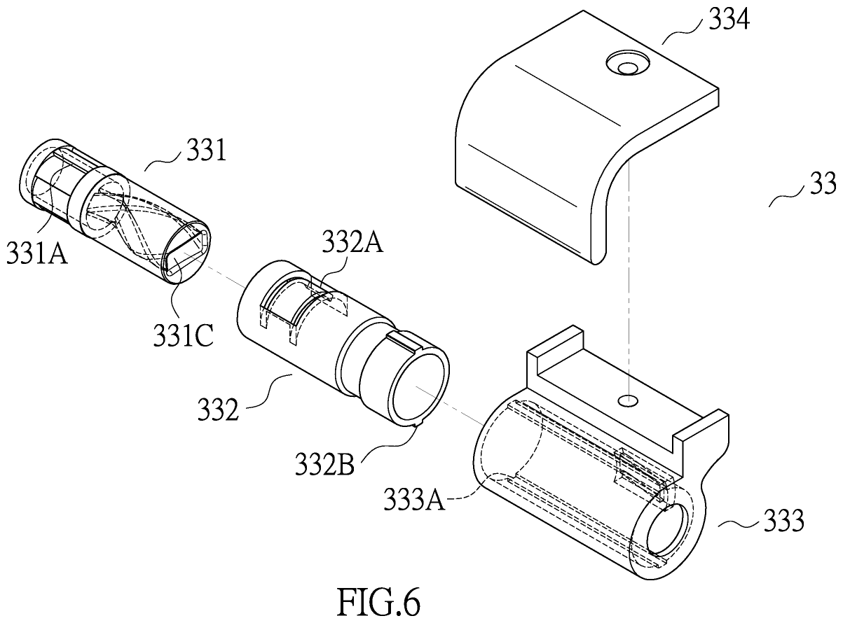

With reference to FIGS. 4 and 6, a connecting sleeve 333 is mounted around the pawl sleeve 332. The pawl sleeve 332 includes two symmetric keys 332B on an outer periphery thereof. The connecting sleeve 333 includes an inner periphery having two symmetric key grooves 333A receiving the two symmetric keys 332B. Thus, the pawl sleeve 332 is restrained in the connecting sleeve 333 in an annular direction and is, thus, more reliable. Furthermore, a handgrip 334 is connected to an outer side of the connecting sleeve 333 to allow manual operation.

When it is desired to unfold the shade 2 of the window shade, the shade 2 can fall down under the action of the gravitational force without being restrained by the screw rod 31. The second gear 11 includes an inner end having a polygonal groove 111. The end of the reel shaft 1 has a polygonal axle 15 corresponding to the polygonal groove 111 of the second gear 11. The reel shaft 1 and the second gear 11 are interlocked through engagement between the polygonal axle 15 of the reel shaft 1 and the polygonal groove 111 of the second gear 11.

Referring to FIG. 5, the first gear 32 is mounted on a portion of a shaft 320. An actuating plate 342 is coupled to an exposed outer end 321 of the shaft 320. The shaft 320 includes an exposed inner end 322 having a polygonal section 322A. The polygonal section 322A extends into an opening 350 of a sleeve 35 coupled to the end of the screw rod 31. The opening 350 has a polygonal groove 351 corresponding to the polygonal section 322A, such that the first gear 32 is driven by the screw rod 31 to rotate when the screw rod 31 rotates. The actuating plate 342 can be moved outwards to actuate the exposed outer end 321 of the shaft 320, thereby disengaging the polygonal section 322A from the polygonal groove 351. Thus, the reel shaft 1 is not interlocked with the screw rod 31.

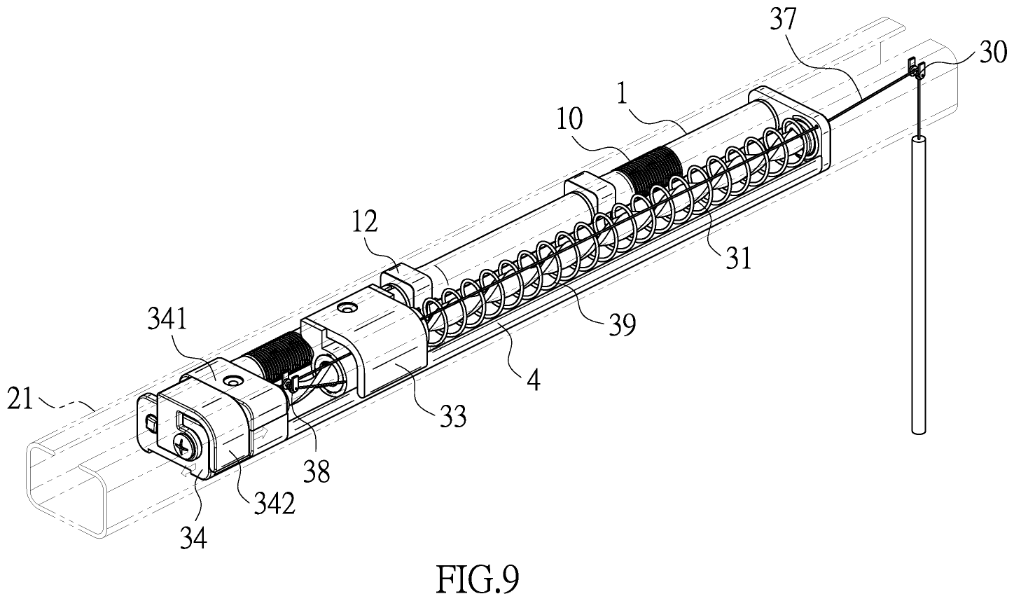

With reference to FIGS. 1-8 and further to FIG. 9, the single direction driving unit 33 can further include a pull cord 37 disposed on a side facing the first gear 32. A roller 38 is securely mounted to the folding/unfolding unit 3, and the pull cord 37 is wound around the roller 38 and extends downwards. Thus, a short user can pull the pull cord 37 to move the single direction driving unit 33 towards the first gear 32. Furthermore, a side of the single direction driving unit 33 opposite to the first gear 32 is connected to an end of an elastic element 39 securely attached to the folding/unfolding unit 3. Thus, when the pull cord 37 is not pulled, the elastic returning force of the elastic element 39 moves the single direction driving unit 33 in a direction away from the first gear 32. The pull cord 37 can be wound around another roller 30 to change the path of the pull cord 37.

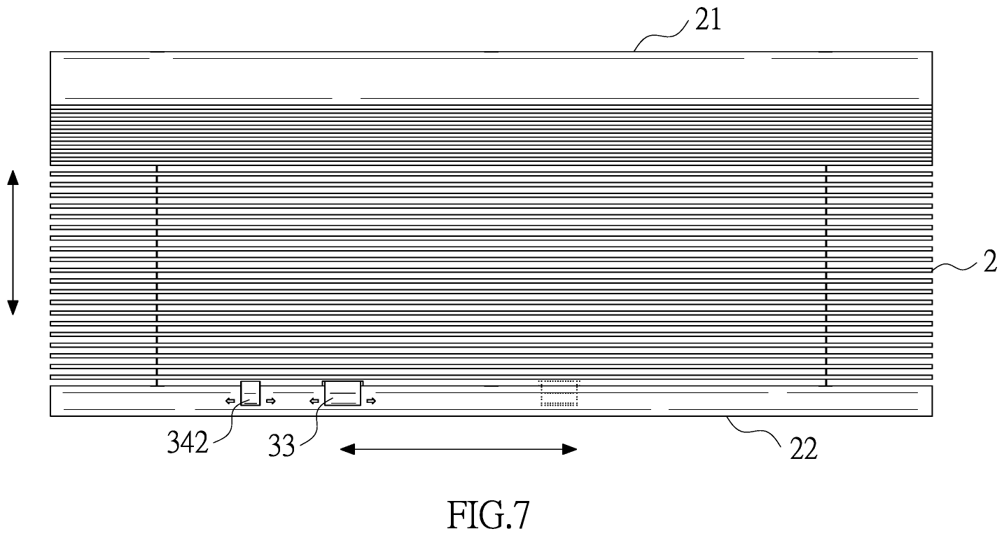

With reference to FIGS. 5 and 7 as well as other figures, the handgrip 334 on the single direction driving unit 33 can be used to interlock the connecting sleeve 333, which, in turn, interlocks the ratchet tooth sleeve 331. Since the pawl 332A of the pawl sleeve 332 and the ratchet tooth edge 331A provide a restraining effect in the reverse direction and a non-restraining effect in the forward direction, when the single direction driving unit 33 moves towards the first gear 32, the pawl 332A engages with the ratchet tooth edge 331A to prevent rotation of the ratchet tooth sleeve 331, and the screw rod 31 rotates to interlock the transmission gear 36 and then the second gear 11, rotating the reel shaft 1. As a result, the string 10 coils around the reel shaft 1 to fold the shade 2. Since the transverse movement of the single direction driving unit 33 affects the coiling extent of the string 10, in a case that a transverse movement of the single direction driving unit 33 is insufficient to fold the shade 2 to the desired extent, the single direction driving unit 33 can be moved back and forth in the directions indicated by the arrows in FIG. 7 until the shade 2 is folded to the desired extent.

Although specific embodiments have been illustrated and described, numerous modifications and variations are still possible without departing from the scope of the invention. The scope of the invention is limited by the accompanying claims.

What is claimed is:

1. A folding/unfolding device for a window shade, with the folding/unfolding device configured to drive a reel shaft to rotate to thereby fold or unfold a shade through a string, with the folding/unfolding device comprising a folding/unfolding unit configured to be mounted to a top frame or a bottom frame of the shade and extending in a transverse direction, wherein the folding/unfolding unit includes a screw rod having an end on which a first gear is mounted, wherein the screw rod is disposed on a side of the reel shaft, wherein a second gear is mounted on an end of the reel shaft and directly or indirectly meshes with the first gear, wherein a single direction driving unit is mounted around and movable along the screw rod, wherein when the single direction driving unit moves along the screw rod and towards the first gear, the screw rod is driven to rotate the reel shaft through the first and second gears, and wherein when the single direction driving unit moves along the screw rod and away from the first gear, the screw rod is not rotated.

2. The folding/unfolding device for the window shade as claimed in claim 1, wherein the single direction driving unit includes a ratchet tooth sleeve having a through-hole extending from an end through another end of the ratchet tooth sleeve, wherein the screw rod extends through the through-hole, wherein the ratchet tooth sleeve includes an inner periphery with a rotational mechanism configured according to a helical form of the screw rod, wherein the ratchet tooth sleeve includes an outer periphery having a ratchet tooth edge, wherein a pawl sleeve is mounted around the ratchet tooth sleeve and includes a pawl movable in an annular path relative to the ratchet tooth edge, wherein when the single direction driving unit moves towards the first gear, the pawl engages with the ratchet tooth edge to prevent rotation of the ratchet tooth sleeve, and the screw rod rotates, and wherein when the single direction driving unit moves away from the first gear, the ratchet tooth sleeve rotates but the screw rod does not rotate.

3. The folding/unfolding device for the window shade as claimed in claim 2, wherein a connecting sleeve is mounted around the pawl sleeve, wherein the pawl sleeve includes two symmetric keys on an outer periphery thereof, wherein the connecting sleeve includes an inner periphery having two symmetric key grooves receiving the two symmetric keys, and wherein a handgrip is connected to an outer side of the connecting sleeve.

4. The folding/unfolding device for the window shade as claimed in claim 1, wherein the first gear is mounted on a portion of a shaft, wherein an actuating plate is coupled to an exposed outer end of the shaft, wherein the shaft includes an exposed inner end having a polygonal section, wherein the polygonal section extends into an opening of a sleeve coupled to the end of the screw rod, wherein the opening has a polygonal groove corresponding to the polygonal section, such that the first gear is driven by the screw rod to rotate when the screw rod rotates, wherein the second gear includes an inner end having a polygonal groove, wherein the end of the reel shaft has a polygonal axle corresponding to the polygonal groove of the second gear, and wherein the reel shaft and the second gear are interlocked through engagement between the polygonal axle of the reel shaft and the polygonal groove of the second gear.

5. The folding/unfolding device for the window shade as claimed in claim 1, wherein the single direction driving unit further includes a pull cord disposed on a side facing the first gear, wherein a roller is securely mounted to the folding/unfolding unit, and wherein the pull cord is wound around the roller and extends downwards.
